(19) United States
(12) Patent Application Publication
(10) Pub. No.: US 2025/0266655 A1
(43) Pub. Date: Aug. 21, 2025

(54) FIBER AMPLIFIER COLD PLATE TO ENABLE KILOWATT POWER LEVEL WITH FREE SPACE LIGHT COUPLING

(71) Applicant: Lumentum Operations LLC, San Jose, CA (US)

(72) Inventors: Simonette PIERROT, Zurich (CH); Ralf KROPF, Zurich (CH); Mark RUHLE BOSCH, Zurich (CH); Guan SUN, San Jose, CA (US); Benedikt HERMANN, Zurich (CH); Matthew KUTSURIS, Dublin, CA (US); Derek A. TUCKER, Milpitas, CA (US)

(21) Appl. No.: 18/748,975

(22) Filed: Jun. 20, 2024

Related U.S. Application Data
(60) Provisional application No. 63/556,184, filed on Feb. 21, 2024.

(51) Int. Cl. H01S 3/04; H01S 3/042; H01S 3/067; H01S 3/094

(52) U.S. Cl. CPC H01S 3/0407; H01S 3/042; H01S 3/06754; H01S 3/094049

(57) ABSTRACT

In some implementations, a free space light coupling system comprises an active fiber; a first set of optical components configured to couple signal light propagating in free space into the active fiber; and a second set of optical components configured to couple pump light propagating in free space into the active fiber. In some implementations, the active fiber is spliced to an endcap at a splice point where the pump light is coupled into the active fiber. In some implementations, the free space light coupling system comprises a metal cold plate having a groove shaped to accommodate the active fiber at the splice point where the pump light is coupled into the active fiber, and the active fiber has a coated section mounted within the groove.

### CROSS-REFERENCE TO RELATED APPLICATION

This Patent Application claims priority to U.S. Provisional Patent Application No. 63/556,184, filed on Feb. 21, 2024, and entitled “FIBER AMPLIFIER COLDPLATE TO ENABLE KILOWATT POWER LEVEL WITH FREE SPACE LIGHT COUPLING.” The disclosure of the prior Application is considered part of and is incorporated by reference into this Patent Application.

### TECHNICAL FIELD

The present disclosure relates generally to a free space light coupling system and to a cold plate design to manage a heat load in a high power free space light coupling system.

### BACKGROUND

Power scaling fiber amplifiers to kilowatt (kW) power levels is often achieved using an all-fiber system that uses optical fibers to carry signal light and pump light. For example, in an all-fiber amplifier, pump light may be coupled into an active fiber using a simple splice between a pump fiber and the active fiber. However, in some circumstances, a free space light coupling system may be used to couple signal light and/or pump light into an active fiber (e.g., to avoid a need to perform a fiber-to-fiber coupling using splices). For example, a free space light coupling system may be configured to efficiently transfer light between optical components without using physical connections such as fibers and/or other waveguide structures. For example, a free space light coupling system may use optical components such as collimators, lenses, and/or mirrors to collimate light from a source, direct the light through free space (e.g., through air or a vacuum), and then focus the light onto one or more receiving components.

### SUMMARY

In some implementations, an optical system includes an active fiber comprising a first end configured to receive signal light and a second end spliced to an endcap at a splice point where pump light is coupled into the active fiber; and a cold plate, made from a metal, having a U-shaped groove to accommodate the active fiber at the splice point where the pump light is coupled into the active fiber, wherein the active fiber has a coated section mounted within the U-shaped groove, and a distance between the coated section of the active fiber and the metal is less than one-hundred micrometers.

In some implementations, a free space light coupling system includes an active fiber; a first set of optical components configured to couple signal light propagating in free space into the active fiber; a second set of optical components configured to couple pump light propagating in free space into the active fiber, wherein the active fiber is spliced to an endcap at a splice point where the pump light is coupled into the active fiber; and a cold plate, made from a metal, having a groove shaped to accommodate the active fiber at the splice point where the pump light is coupled into the active fiber, wherein the active fiber has a coated section mounted within the groove.

In some implementations, a metal cold plate includes a U-shaped groove to accommodate an active fiber at a splice point where pump light is coupled into the active fiber, wherein: the active fiber has a coated section mounted within the U-shaped groove, and a distance between the coated section of the active fiber and the metal cold plate is less than one-hundred micrometers; and a V-shaped groove to accommodate an endcap spliced to the active fiber at the splice point, wherein the endcap is clamped within the V-shaped groove, and wherein a center of the U-shaped groove is aligned with a center of the endcap such that a bare section of the active fiber, near the splice point, is not in contact with the metal cold plate.

### BRIEF DESCRIPTION OF THE DRAWINGS

FIG. 1 is a diagram illustrating an example of a free space light coupling system.

FIGS. 2A-2F are diagrams illustrating examples associated with a fiber amplifier cold plate to enable power scaling to kilowatt power levels in a free space light coupling system.

### DETAILED DESCRIPTION

The following detailed description of example implementations refers to the accompanying drawings. The same reference numbers in different drawings may identify the same or similar elements.

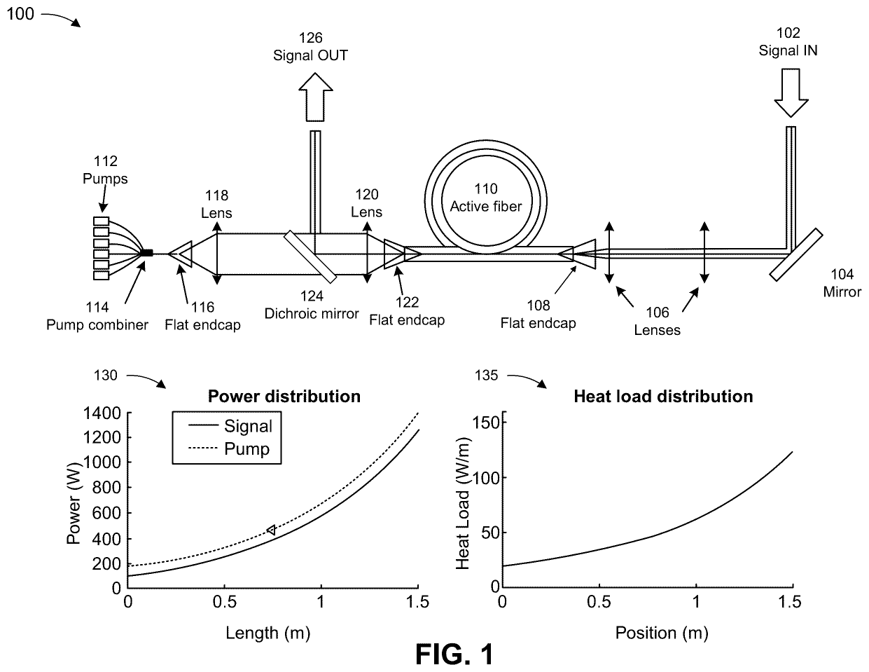

FIG. 1 is a diagram illustrating an example 100 of a free space light coupling system. More particularly, as described herein, power scaling a fiber amplifier to kilowatt (kW) power levels may be achieved using an all-fiber amplifier that includes various components that are spliced together. For example, in an all-fiber amplifier, an active fiber may receive signal light at a first end (e.g., directly from a source, or via an input fiber spliced to the active fiber at the first end), and pump light may be coupled into the active fiber via a pump fiber at a second end to load the active fiber with energy to amplify the signal light. However, for ultrafast lasers (e.g., femtosecond or picosecond lasers), signal light and pump light may be free space coupled into the active fiber (e.g., rather than via a fiber-to-fiber coupling that uses splices) due to various constraints, such as a need to minimize a fiber length into which short pulses are propagating (e.g., to avoid nonlinear effects and/or fiber damage). In particular, in a free space light coupling system, pump light and signal light propagate in free space, and optical components such as lenses and mirrors are used to shape, steer, and eventually couple the pump light and the signal light into an active fiber.

For example, in the free space light coupling system shown in FIG. 1, signal light 102 originating at a first laser source may propagate in free space (e.g., air or a vacuum) and reflect off a mirror 104 before passing through one or more lenses 106 that are used for beam shaping before being coupled into an active fiber 110 via a flat endcap 108 disposed at a first end of the active fiber. Furthermore, multiple pump diodes 112 that generate pump light are combined using a pump combiner 114 to generate a powerful pump beam with a power level up to multiple kW. As shown in FIG. 1, the pump combiner 114 may be coupled to a flat endcap 116 that causes the pump light to diverge into free space, where the pump light propagating in free space is then collimated using a first lens 118 and focused using a second lens 120 to couple the pump light into the active fiber 110 via a flat endcap 122 disposed at a second end of the active fiber 110. Accordingly, the active fiber 110 typically contains dopants (e.g., rare-earth elements such as erbium (Er) or ytterbium (Yb)) that can actively interact with light to induce stimulated photon emission and boost signal power, where the pump light provides energy that is used to amplify the signal light to a higher power level within the active fiber 110. As further shown, a dichroic mirror 124 may be provided to separate the pump light and the signal light such that amplified signal light 126 that is output by the active fiber 110 may propagate in free space and reflect off the dichroic mirror 124 toward one or more receiving components.

Although a free space light coupling system may offer advantages over an all-fiber amplifier in various scenarios, power scaling a fiber amplifier to kW power levels using a free space light coupling system poses various challenges, including a very high heat load. For example, in the free space light coupling system shown in FIG. 1, a hot spot or hot area is created at a location where the pump light is coupled to the active fiber 110 (e.g., at or near the endcap 122) due to the absorption of the pump light by the active fiber 110. For example, referring to FIG. 1, plot 130 illustrates a power distribution of the signal light and the pump light in a configuration where the signal light has a power level of 100 watts (W) and the pump light has a power level of 1400 W, and plot 135 illustrates a heat load distribution that corresponds to a temperature profile along the active fiber 110. In the free space light coupling system shown in FIG. 1, a location where the signal light 102 is coupled into the active fiber 110 (e.g. at or near the endcap 108) corresponds to a length of 0 meters (m) in plot 130 and to a position of 0 m in plot 135, and the location where the pump light is coupled into the active fiber 110 (e.g. at or near the endcap 122) corresponds to a length of 1.5 m in plot 130 and a position of 1.5 m in plot 135 in a counter propagating scheme. As shown in the heat load distribution curve, a heat load within the active fiber 110 is at a maximum (e.g., approximately 122.9 W/m) on the pump coupling side at a position of 1.5 m, and the heat load gradually decreases toward the signal coupling side as the pump light propagates through the active fiber 110 and is absorbed by the active fiber 110. Accordingly, one challenge in designing an optical system that uses free space light coupling is to mount the active fiber 110 in such a way that the active fiber 110 can be efficiently cooled, especially near the pump coupling side.

As indicated above, FIG. 1 is provided as an example. Other examples may differ from what is described with regard to FIG. 1. For example, the number and arrangement of devices shown in FIG. 1 are provided as examples. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices shown in FIG. 1 may perform one or more functions described as being performed by another set of devices shown in FIG. 1.

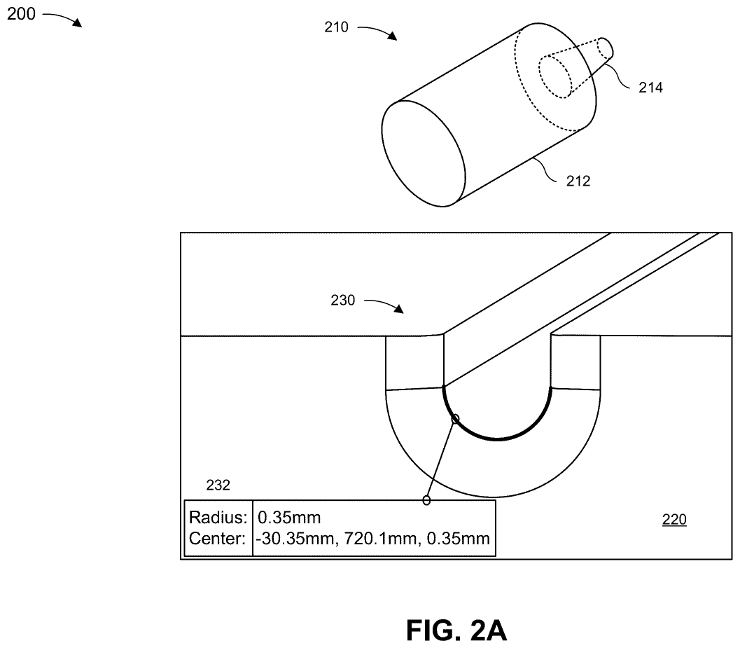

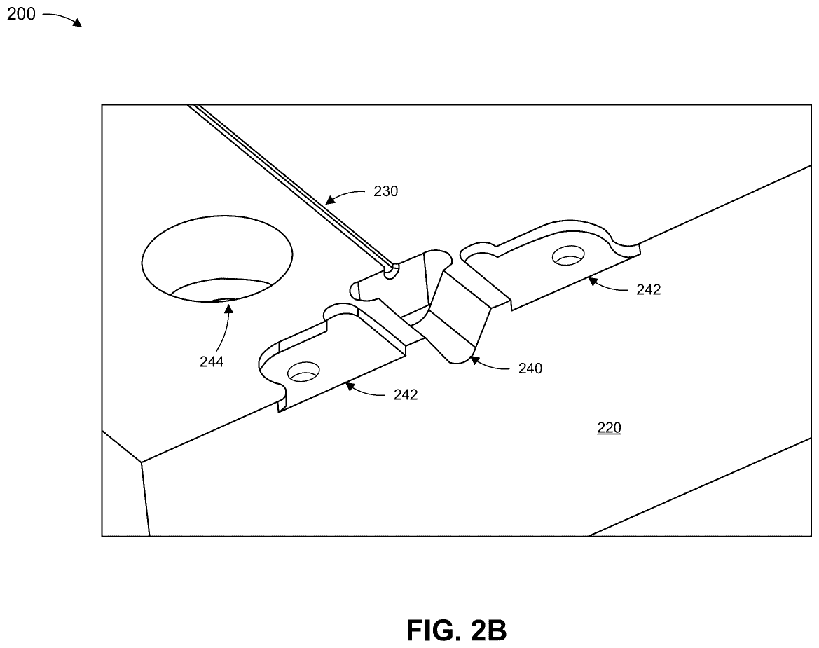

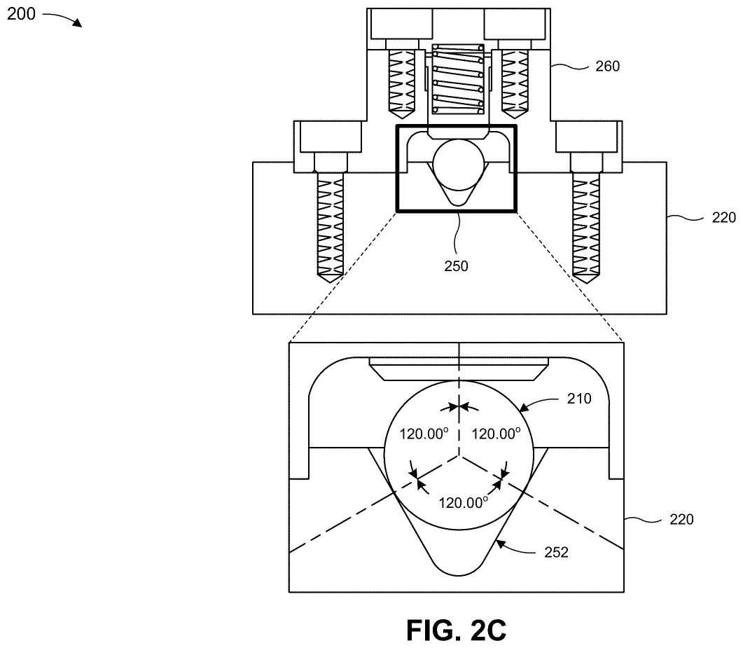

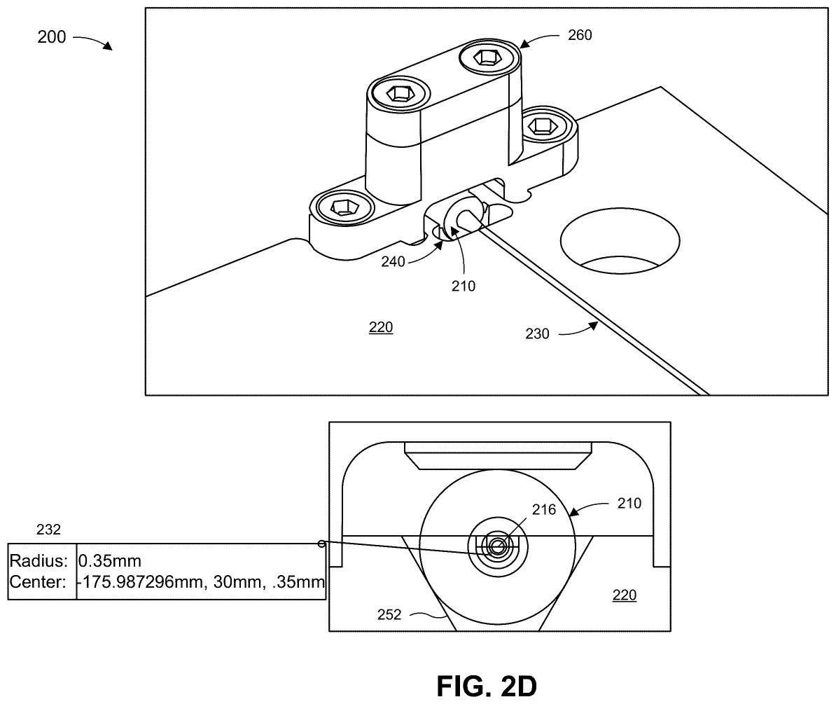

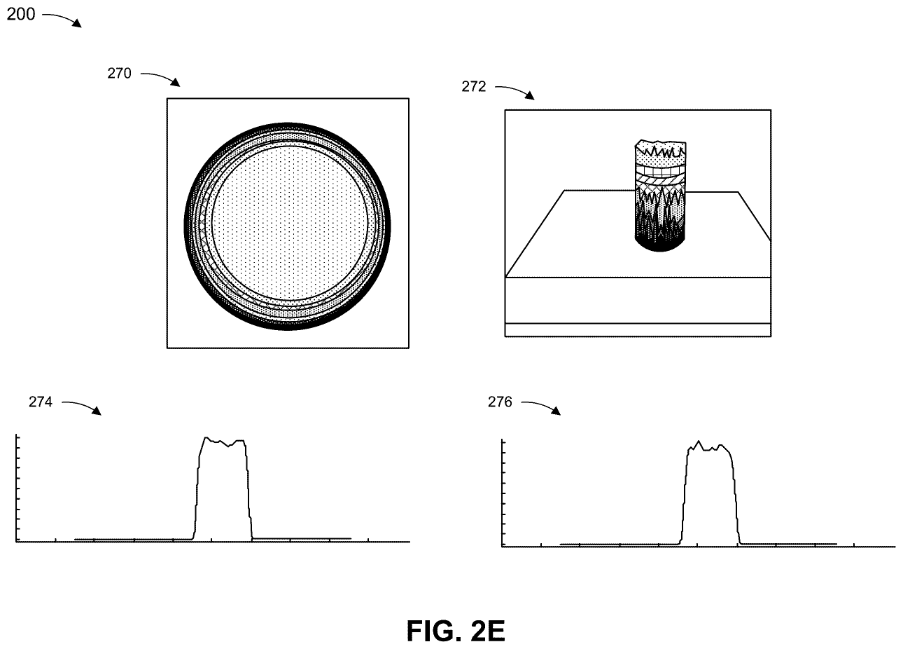

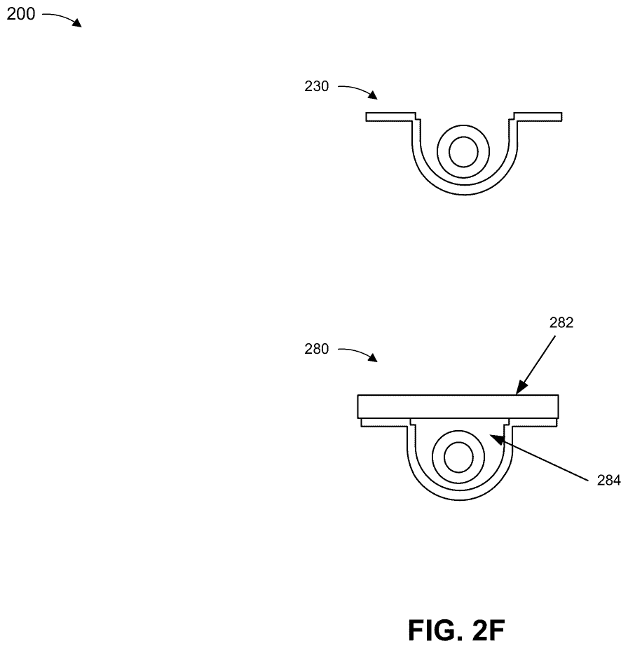

FIGS. 2A-2F are diagrams illustrating examples 200 associated with a fiber amplifier cold plate to enable power scaling to kW power levels in a free space light coupling system. More particularly, as described herein, a cold plate design may be used to efficiently cool an active fiber in a free space light coupling system and enable power scaling to kW power levels. For example, as described herein, the cold plate design may minimize scattered light at or near a location where pump light propagating in free space is coupled into an active fiber, may maximize a surface area of the active fiber that is connected to the cold plate either directly or via a highly thermally conducting material, and may ensure that the active fiber is as close to the cold plate metal as possible (e.g., within 100 micrometers (μm)) to enable efficient cooling.

For example, as described herein, a free space light coupling system may generally include an active fiber with a first end spliced to a first endcap at a first splice point where signal light is coupled into the active fiber and a second end spliced to a second endcap at a second splice point where pump light is coupled into the active fiber. In some implementations, FIG. 2A illustrates an example endcap 210 that may be spliced to the active fiber at both ends. For example, in some implementations, the endcap 210 may be made entirely from glass, and may have a geometry that causes a diverging beam emitted from the active fiber at the splice point to be contained with a glass volume of the endcap 210. Accordingly, when used together with a signal beam and a pump beam, the endcap 210 contains both the signal beam and the pump beam within the glass volume of the endcap 210. In some implementations, the geometry may be shaped according to a shape of an endcap holder in a metal cold plate 220 (e.g., described in more detail elsewhere herein). For example, as shown in FIG. 2A, the endcap 210 includes a cylindrical portion 212 where light propagating in free space enters the endcap 210 and a frustum portion 214 (e.g., shaped like a truncated cone) that is spliced to the active fiber. In some implementations, the active fiber may be spliced to the endcap 210 at both ends to protect the fragile ends of the active fiber and also to lower a light intensity at the end of the active fiber. When light exits the active fiber, the beam diverges and the beam size is significantly larger when the beam reaches the facet of the endcap 210 (e.g., at a distal end of the frustum portion 214, situated farther away from the cylindrical portion 212, which allows an average power and a peak power intensity to be reduced). For example, the active fiber typically has a very small diameter (e.g., approximately 500 μm), which makes the active fiber more fragile and/or susceptible to burning when carrying light at a high power level.

Accordingly, splicing the active fiber to a glass endcap 210 with the geometry shown in FIG. 2A results in a larger beam at the output facet, which reduces the power density and allows the active fiber to be mechanically held in a desired position. For example, as described herein, the hottest spot in a free space light coupling system is typically at the splice point between the active fiber and the endcap 210 at the pump coupling side. Accordingly, in some implementations, a thermal and mechanical connection to a cold plate 220 may be provided at the splice point between the active fiber and the endcap 210 at the pump coupling side. For example, in some implementations, the cold plate 220 may be made of a material that has a high thermal conductivity (e.g., a thermal conductivity that satisfies a threshold associated with a heat sinking application). For example, materials with a high thermal conductivity can effectively transfer heat and/or absorb heat from an environment, and thermal conductivity is typically measured in Watts per meter per degree Kelvin (W/mK). Accordingly, in some implementations, the cold plate 220 may be made from a metal (e.g., silver, copper, gold, aluminum, or another suitable metal or alloy) that may be actively cooled with water). Furthermore, the active fiber is generally coated with a low index coating that has a light-guiding property, where the coating may need to be removed near the splice point to the endcap 210. Accordingly, a section of the active fiber near the splice point may be bare, and the bare section of the active fiber does not contact the metal (e.g., to prevent burning). However, to ensure a sufficient thermal connection to cool the active fiber near the splice point, the cold plate 220 may be designed to hold the active fiber as close as possible to the metal of the cold plate 220 without allowing the bare section of the active fiber to be in contact with the metal. Furthermore, the free space light coupling system may be designed to reduce scattered light that can heat up the surroundings of the active fiber, including the cold plate 220, the endcap fixture elements, and/or an adhesive, to prevent failure by burning the active fiber.

For example, as shown in FIG. 2A, the cold plate 220 may have a grooved design to hold the active fiber. For example, as shown in FIG. 2A, the cold plate may have a U-shaped groove 230 with dimensions to ensure that a separation between a coated section of the active fiber and the metal of the cold plate 220 satisfies (e.g., is less than or equal to) a threshold, such as 100 μm. For example, in the design shown in FIG. 2A, the U-shaped groove 230 has dimensions 232 to accommodate a coated fiber with a 570 μm diameter (including the coating). With a 720 μm groove, the separation between the coating of the active fiber and the metal is about 65 μm, which satisfies (e.g., is less than) the threshold of 100 μm. In some implementations, the separation between the coating of the active fiber and the metal is generally as small as possible within the applicable mechanical tolerances and acceptable thermally-induced mechanical stress on the splice point between the active fiber and the endcap 210.

Furthermore, as shown in FIG. 2B, the U-shaped groove 230 may have smooth edges to allow a transition to an endcap holder 240 (e.g., a recessed region in the cold plate 220 that has a geometry shaped to accommodate the geometry of the endcap 210). For example, as shown in FIG. 2B, the endcap holder 240 has a V-shaped groove to accommodate the frustum portion 214 of the endcap 210. In some implementations, the endcap holder 240 may be shaped to hold the endcap 210 and the fiber spliced to the endcap 210, without creating stress that may otherwise break the fragile splice point, especially when exposed to very high heat loads. Furthermore, as shown in FIG. 2B, the cold plate 220 includes a pair of recessed sections 242 that are shaped to receive a clamp that may be used to secure the endcap 210 within the endcap holder 240, and a circular recess 244 to hold a post of the cold plate 220 (e.g., mechanically securing the cold plate 220 in place within the free space light coupling system).

For example, as shown in FIG. 2C, the endcap 210 may be clamped within the V-groove 252 with a suitable force applied to the endcap 210 using a spring-loaded shaft 260 or other suitable mechanism. For example, a spring force may be applied to avoid placing stress on the endcap 210 within the endcap holder 240. For example, reference number 250 refers to an area where the endcap 210 is positioned in the V-groove 252 of the cold plate 220 after the endcap 210 has been positioned and appropriately clamped within the endcap holder 240 adjacent to the U-shaped groove 230 for holding the active fiber. As shown in FIG. 2C, the endcap 210 is clamped at three points that are separated by 120 degree angles, which provides the endcap 210 with stability when clamped within the V-groove 252 and reduces stress that may occur when there is a high heat load at the splice point between the active fiber and the endcap 210.

Referring to FIG. 2D, the topmost diagram illustrates the endcap 210 clamped within the endcap holder 240 by the spring-loaded shaft 260, adjacent to the U-groove 230 that is formed in the cold plate 220 to accommodate the active fiber. Furthermore, as described herein, near the splice point between the endcap 210 and the active fiber, a section of the fiber (e.g., approximately 15 millimeters (mm) long) is bare (e.g., the coating is removed). In one example, assuming that the active fiber has a 570 μm diameter with the coating, the bare section of the active fiber may have a 414 μm diameter without the coating. The bare section of the active fiber generally cannot touch the metal of the cold plate 220, because contact between the bare section of the active fiber and the metal of the cold plate 220 could burn the fiber. Accordingly, a center 216 of the U-shaped groove 230 and a center of the endcap 210, while held in the V-groove 252, may be aligned to satisfy an alignment tolerance (or threshold) that ensures that the bare section of the active fiber does not contact the metal of the cold plate 220.

In some implementations, the active fiber may be held in place within the U-shaped groove 230 of the cold plate 220 using a suitable adhesive, such as a transparent glue. For example, an opaque glue or an opaque adhesive with a high thermal conductivity may generally exhibit worse thermal properties than a transparent glue with a lower thermal conductivity (e.g., due to scattered light being absorbed by the opaque material and heating up). Accordingly, because a transparent adhesive may absorb less light than an opaque adhesive, the active fiber may be held in place within the U-shaped groove 230 of the cold plate 220 using a transparent glue or other suitable adhesive material that has a low absorption at a wavelength of the pump light that is coupled into the active fiber via the endcap 210.

As shown in FIG. 2E, the cold plate 220 may be designed to minimize scattered light near a pump coupling side in a free space light coupling system. For example, to couple pump light that is propagating in free space into the active fiber, a facet of a pump fiber may be imaged into the active fiber. In some implementations, a set of one or more aspherical lenses may be used to provide a sharp image and a flat top profile. For example, with proper magnification in a set of aspherical lenses, a flat top transverse profile can be generated without any light outside of the flat top. An example of a suitable flat top transverse profile is shown by reference numbers 270, 272, 274, and 276 in FIG. 2E. In some implementations, the light exiting the pump fiber may be propagating into a cone (e.g., the frustum portion 214 of the endcap 210) with a divergence angle that is defined according to a numerical aperture (NA). Although the NA is specified, some light can propagate outside the specified NA, and such light poses a risk to heat up the surroundings of the active fiber. Accordingly, to block the light with the high NA (e.g., exceeding a specified threshold), a hard aperture can be used in a path of the pump beam (e.g., at a location where the beam is collimated, or near the fiber facet). In this way, scattered light near the fiber end where the pump light is coupled into the active fiber may be minimized, which may reduce a risk that high NA light or scattered light will heat up the fiber surroundings and cause a burned fiber failure.

In some implementations, as shown in FIG. 2F, the cold plate 220 may be designed with a U-shaped groove 230, as described in more detail above. In some implementations, as shown by reference number 280 in FIG. 2F, the cold plate 220 may have a groove design in which a top portion of the U-shaped groove 230 is closed by a covering structure 282 to further enable cooling from above. Furthermore, as shown by reference number 284, a gap between the active fiber and the U-shaped groove 230 may be filled with a transparent glue or other suitable adhesive, and a covering structure 282 made from a material with a high thermal conductivity may be connected to the cold plate 220 from above. For example, in some implementations, the covering structure 282 used to close the top or lid of the U-shaped groove 230 may be a transparent material, such as diamond, a metal material, such as copper, or another suitable material with a thermal conductivity that satisfies (e.g., equals or exceeds) a threshold associated with a heat sinking application. For example, diamond is the material with the highest known thermal conductivity (e.g., ˜2000 W/mK), conducting heat one order of magnitude better than aluminum (e.g., ˜237 W/mK). Accordingly, diamond is a suitable material for demanding heat sinking applications, such as efficiently cooling one or more regions in a free space light coupling system. In some implementations, the gap between the fiber and the top plate or covering structure may be as small as mechanical tolerances permit. In some implementations, the top plate may be extended to an area near a pump coupling side over a couple or several centimeters, which may mitigate a need to have the U-shaped groove 230 closed over the entire fiber length. For example, as described herein, a thermal distribution along the active fiber is not uniform along the fiber length, and is highest near the pump coupling side. Cooling the entire fiber with one or more top plates may be unnecessary to maintain the overall peak temperature below a damage threshold associated with the fiber coating and adhesive at the splice point. However, cooling the entire fiber using one or more top plates may further reduce a thermally-induced group velocity mismatch, which is important in some applications, such as efficient recombination of ultra-short pulses. Accordingly, in some cases, one or more top plates may enclose an entire length of the active fiber, or may enclose only a portion of the active fiber.

Accordingly, some implementations described herein relate to a metal cold plate 220 with a design and heat load management techniques that may be used when performing free space coupling of a high power pump beam to an active fiber. In some implementations, the cold plate 220 design and heat load management techniques may be suitable for any industrial fiber system or other optical system based on an all-fiber pump light coupling system (e.g., using lenses and mirrors), particularly where a connection between various optical elements is made using splicing processes. For example, in some implementations, an optical system that enables kW power scaling with free space pump coupling may include a fiber endcap 210 spliced to an active fiber, a fiber endcap holder 240 connected to a cold plate 220 that is actively cooled (e.g., using water), a U-shaped groove 230 with a geometry to minimize a fiber-to-metal distance while avoiding contact between bare fiber and metal, a transparent glue or adhesive to fix the fiber in the U-shaped groove 230 with a low absorption at the pump wavelength, and a scattered light management system that includes aspherical lenses that telescope to image a pump fiber facet, shape the pump beam, and create a sharp flat top profile with a suitable size and/or a hard aperture to block high NA light.

As indicated above, FIGS. 2A-2F are provided as examples. Other examples may differ from what is described with regard to FIGS. 2A-2F. For example, the number and arrangement of devices shown in FIGS. 2A-2F are provided as examples. In practice, there may be additional devices, fewer devices, different devices, or differently arranged devices than those shown in FIGS. 2A-2F. Furthermore, two or more devices shown in FIGS. 2A-2F may be implemented within a single device, or a single device shown in FIGS. 2A-2F may be implemented as multiple, distributed devices. Additionally, or alternatively, a set of devices shown in FIGS. 2A-2F may perform one or more functions described as being performed by another set of devices shown in FIGS. 2A-2F.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical system, comprising:
an active fiber comprising a first end configured to receive signal light and a second end spliced to an endcap at a splice point where pump light is coupled into the active fiber; and
a cold plate, made from a metal, having a U-shaped groove to accommodate the active fiber at the splice point where the pump light is coupled into the active fiber, wherein:
the active fiber has a coated section mounted within the U-shaped groove, and
a distance between the coated section of the active fiber and the metal is less than one-hundred micrometers.

2. The optical system of claim 1, wherein the endcap has a geometry that causes a beam to diverge when emitted from the active fiber at the splice point.

3. The optical system of claim 1, wherein the cold plate has a V-shaped groove to accommodate the endcap, and wherein the endcap is clamped within the V-shaped groove.

4. The optical system of claim 3, wherein a center of the U-shaped groove is aligned with a center of the endcap such that a bare section of the active fiber, near the splice point, is not in contact with the metal.

5. The optical system of claim 1, wherein the coated section is mounted within the U-shaped groove using a transparent adhesive.

6. The optical system of claim 5, wherein the transparent adhesive has a low absorption of light at a wavelength of the pump light.

7. The optical system of claim 1, further comprising:
one or more aspherical lenses configured to couple the pump light into the active fiber with a flat top transverse profile.

8. The optical system of claim 1, further comprising:
a hard aperture in a path of a beam carrying the pump light to block a portion of the pump light that has a numerical aperture exceeding a threshold.

9. The optical system of claim 1, further comprising:
a covering structure, disposed over the U-shaped groove, wherein the covering structure is made from diamond, metal, or a material with a thermal conductivity that satisfies a threshold associated with a heat sinking application.

10. The optical system of claim 9, wherein the covering structure encloses only a portion of the active fiber near the splice point where the pump light is coupled into the active fiber.

11. The optical system of claim 9, wherein the covering structure encloses an entire length of the active fiber.

12. A free space light coupling system, comprising:
an active fiber;
a first set of optical components configured to couple signal light propagating in free space into the active fiber;
a second set of optical components configured to couple pump light propagating in free space into the active fiber,
wherein the active fiber is spliced to an endcap at a splice point where the pump light is coupled into the active fiber; and
a cold plate, made from a metal, having a groove shaped to accommodate the active fiber at the splice point where the pump light is coupled into the active fiber,
wherein the active fiber has a coated section mounted within the groove.

13. The free space light coupling system of claim 12, wherein the endcap has a geometry that causes a beam to diverge when emitted from the active fiber at the splice point.

14. The free space light coupling system of claim 12, wherein the groove is a first groove, and wherein the cold plate has a second groove to accommodate the endcap.

15. The free space light coupling system of claim 12, wherein the coated section is mounted within the groove using a transparent adhesive.

16. The free space light coupling system of claim 12, further comprising:
one or more aspherical lenses configured to couple the pump light into the active fiber with a flat top transverse profile.

17. The free space light coupling system of claim 12, further comprising:
a hard aperture in a path of a beam carrying the pump light to block a portion of the pump light that has a numerical aperture exceeding a threshold.

18. The free space light coupling system of claim 12, further comprising:
a covering structure, disposed over the groove, wherein the covering structure is made from diamond, metal, or a material with a thermal conductivity that satisfies a threshold associated with a heat sinking application.

19. A metal cold plate, comprising:
a U-shaped groove to accommodate an active fiber at a splice point where pump light is coupled into the active fiber, wherein:
the active fiber has a coated section mounted within the U-shaped groove, and
a distance between the coated section of the active fiber and the metal cold plate is less than one-hundred micrometers; and
a V-shaped groove to accommodate an endcap spliced to the active fiber at the splice point, wherein the endcap is clamped within the V-shaped groove, and wherein a center of the U-shaped groove is aligned with a center of the endcap such that a bare section of the active fiber, near the splice point, is not in contact with the metal cold plate.

20. The metal cold plate of claim 19, further comprising:
a covering structure, disposed over the U-shaped groove, wherein the covering structure is made from diamond, metal, or a material with a thermal conductivity that satisfies a threshold associated with a heat sinking application.
